(19) United States
(12) Patent Application Publication
(10) Pub. No.: US 2023/0271813 A1
(43) Pub. Date: Aug. 31, 2023

(54) COMBINATION OF UNITS FOR WORK MACHINE

(71) Applicant: KOBELCO CONSTRUCTION MACHINERY CO., LTD., Hiroshima-shi (JP)

(72) Inventors: Keiko INADA, Hyogo (JP); Daisuke TAKAOKA, Hyogo (JP); Takahiro OKA, Hyogo (JP)

(73) Assignee: KOBELCO CONSTRUCTION MACHINERY CO., LTD., Hiroshima-shi (JP)

(21) Appl. No.: 18/044,893

(22) PCT Filed: Oct. 6, 2021
(86) PCT No.: PCT/JP2021/037024

§ 371 Date: Mar. 10, 2023

(30) Foreign Application Priority Data
Oct. 22, 2020 (JP) 2020-177368

(51) Int. Cl. B66C 23/66

(52) U.S. Cl. CPC B66C 23/66

(57) ABSTRACT

A combination of a first unit and a second unit are to be rotatably interconnected through a pin. The first unit includes a first unit body provided with a first pin hole, a first contact member, and a fastening member. The first contact member has a first contact surface. The second unit includes a second unit body provided with a second pin hole, and a second contact surface. The second contact surface is contactable with the first contact surface. The fastening member fastens the first contact member to the first unit body so as to allow the relative position of the first contact member to the first unit body to be adjusted.

### TECHNICAL FIELD

The present invention relates to a unit combination included in a work machine, including a first unit and a second unit to be interconnected through a pin capably of relative rotation to each other.

### BACKGROUND ART

A typical work machine includes a first unit and a second unit to be interconnected through a pin. The examples of the first unit and the second unit include an upper turning body and a boom connected to the upper turning body rotatably in a derricking direction. As a technique for facilitating such a connection, for example, FIGS. 8 and 9 of Patent Literature 1 disclose a technique for centering a boom-side pin hole provided in a foot part of a boom in a crane and a bracket-side pin hole provided in a foot bracket of the upper turning body. The technique includes: fixing an annular member to the foot part, the annular member enclosing the boom-side pin hole; and providing a reception seat on the foot bracket, the reception seat being capable of receiving the annular member. The reception seat receives the annular member to allow the foot-side pin hole and-the bracket side pin hole to be centered (aligned).

The technique, however, hardly allows the accuracy of the centering to be improved. Specifically, for allowing the boom to rotate in the derricking direction relatively to the upper turning body with the pin inserted into the boom-side pin hole and the bracket-side pin hole, it is required to secure a suitable size of clearance between the annular member and the reception seat so as to prevent the annular member and the reception seat from mutual contact during the rotation. The larger the clearance, the lower the accuracy of the centering of the boom-side pin hole and the bracket-side pin hole, increasing a required force for inserting the pin into both pin holes. This prevents the foot part and the foot bracket from facile interconnection. Rendering the clearance small, conversely, increases the risk of interference between the annular member and the reception seat to inhibit normal rotation. There is, thus, a problem of difficulty in centering the foot side and the bracket side pin hole with high accuracy while securing normal rotation of the boom relative to the upper turning body. The problem can occur in not only the interconnection between the upper swing body and the boom but also the interconnection of other units through a pin.

### CITATION LIST

### Patent Literature

Patent Literature 1: Japanese Unexamined Patent Publication No. 2006-282287

### SUMMARY OF INVENTION

It is an object of the present invention to provide a unit combination included in a work machine, the unit combination including a first unit and a second unit to be interconnected through a pin capably of relative rotation to each other and allowing the first and second units to be easily interconnected while securing normal relative rotation of the first and second units.

Provided is a unit combination included in a work machine, the unit combination comprising a first unit and a second unit. Each of the first unit and the second unit is a component of the work machine. The second unit is connectable to the first unit through a pin so as to be rotatable relatively to the first unit about a rotation axis and detachable from the first unit. The first unit includes a first unit body, a first contact member, and at least one fastening member. The first unit body is provided with a first pin hole, which allows the pin to be inserted through the first pin hole in a rotation-axis direction. The rotation-axis direction is a direction parallel to the rotation axis. The first contact member has a first contact surface, which extends along an arc having a center on a center axis of the first pin hole when viewed in the rotation-axis direction. The second unit includes a second unit body and a second contact part. The second unit body is provided with a second pin hole, which allows the pin to be inserted through the second pin hole in the rotation-axis direction. The second contact part has a second contact surface, which extends along an arc having a center on a center axis of the second pin hole when viewed in the rotation-axis direction and is contactable with the first contact surface. The fastening member fastens the first contact member to the first unit body so as to allow a relative position of the first contact member to the first unit body to be adjusted in a direction orthogonal to the rotation-axis direction.

### BRIEF DESCRIPTION OF DRAWINGS

FIG. 1 is a side view of a work machine according to an embodiment of the present invention;

FIG. 2 is a side view of a boom distal end in the work machine and a lower jib connected thereto;

FIG. 3 is a perspective view showing a pin and the periphery thereof, the pin provided to interconnect a first unit, which is the boom, and a second unit, which is the lower jib;

FIG. 4 is a side view showing the pin and the periphery thereof;

FIG. 5 is a side view showing a first pin hole in the first unit and the periphery thereof;

FIG. 6 is a bottom view of the pin shown in FIG. 4 and the periphery thereof, which are viewed in the direction indicated by arrow F6 in FIG. 4; and

FIG. 7 is a bottom view showing the first pin hole and the periphery thereof in the first unit.

### DETAILED DESCRIPTION

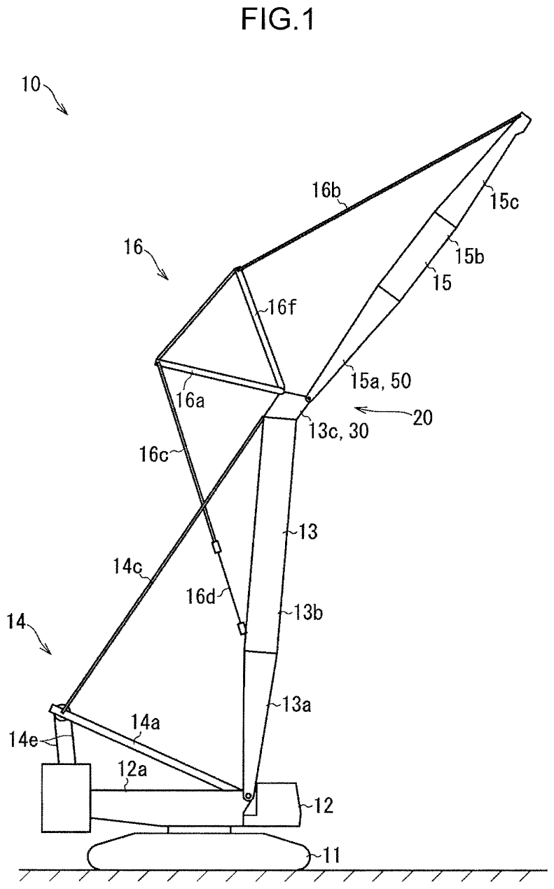

There will be described an embodiment of the present invention with reference to FIGS. 1 to 7.

FIG. 1 shows a work machine 10 according to the embodiment. The work machine 10 is a machine for performing a work, for example, a construction machine for performing a construction work, for example, a crane. The work machine 10 illustrated in FIG. 1 is a lattice boom crawler crane. The work machine 10 is configured to be disassemblable. The work machine 10 is transported in a state of being disassembled. The work machine 10 includes a lower traveling body 11, an upper turning body 12, a boom 13, a boom derricking device 14, a jib 15, and a jib derricking device 16

The lower traveling body 11 makes a traveling motion. The lower traveling body 11 may include either a pair of left and right crawlers or a plurality of wheels. If being a crane, the work machine 10 may be either a crawler crane or a wheel crane.

The upper turning body 12 is turnably mounted on the lower traveling body 11. The upper turning body 12 includes a turning frame 12a capable of turning.

The boom 13 is connected to the turning frame 12a of the upper turning body 12 capably of derricking. The boom 13 has opposite ends in the longitudinal direction of the boom 13, namely, a boom longitudinal direction. One of the opposite ends is a boom proximal end to be connected to the turning frame 12a rotatably vertically, and the other is a boom distal end.

The boom 13 is disassemblable in the boom longitudinal direction. Specifically, the boom 13 includes a plurality of boom elements aligned in the boom longitudinal direction, namely, a lower boom 13a, an intermediate boom 13b, and an upper boom 13c. The lower boom 13a includes a proximal end that forms the boom proximal end and a distal end opposite thereto. The boom 13 has a lattice structure. The intermediate boom 13b has a proximal end to be connected to the distal end of the lower boom 13a, that is, the end opposite to the upper turning body 12, and a distal end opposite thereto. The upper boom 13c has a proximal end to be connected to the distal end of the intermediate boom 13b and a distal end opposite thereto, the distal end forming the boom distal end. The upper boom 13c may be either a substantially hexahedral member, such as a tower cap or a boom top, or a member extending in the boom longitudinal direction.

The boom derricking device 14 is a device to derrick the boom 13 with respect to the upper turning body 12, specifically, to rotate the boom 13 vertically with respect to the upper turning body 12 about the boom proximal end. The boom derricking device 14 includes a mast 14a, a boom guy line 14c, a boom derricking rope 14e, and an unillustrated boom derricking winch. The mast 14a is attached to the turning frame 12a of the upper turning body 12 so as to be derrickable, specifically, vertically rotatable around the lower end of the mast 14a. The boom guy line 14c is connected to the distal of the mast 14a and the distal end of the boom 13 to join the distal ends with each other. The boom derricking rope 14e is wound around a spreader provided at the distal end of the mast 14a and the boom derricking winch. The boom derricking winch performs winding and unwinding the boom derricking rope 14e to derrick the mast 14a with respect to the upper turning body 12, thereby derricking the boom 13 with respect to the upper turning body 12.

The boom derricking device 14 may include a gantry in place of the mast 14a. The gantry includes a compression member and a tension member. The compression member is attached to the turning frame 12a of the upper turning body 12 at a position similar to that of the mast 14a. The tension member is connected to the distal end of the compression member and a rear end of the upper turning body 12 to interjoin them. The distal end of the compression member and the distal end of the boom 13 are interconnected through a boom guy line 14c and a boom derricking rope 14e. Also in this case, the boom derricking winch performs winding and unwinding the boom derricking rope 14e to thereby derrick the boom 13 with respect to the upper turning body 12.

The jib 15 is connected to the boom distal end, namely, the upper boom 13 in the present embodiment, capably of derricking. The jib 15 has a lattice structure. The jib 15 has opposite ends in the longitudinal direction of the jib 15, namely, a jib longitudinal direction. One of the opposite ends is a jib proximal end that is connected to the distal end of the boom 13 rotatably vertically, and the other is a jib distal end.

The jib 15 is capable of being disassembled in the jib longitudinal direction. Specifically, the jib 15 includes a plurality of jib elements aligned in the jib longitudinal direction, namely, a lower jib 15a, an intermediate jib 15b, and an upper jib 15c. The lower jib 15a has a proximal end forming the jib proximal end, that is, an end on the side close to the boom 13, and a distal end opposite thereto, and the proximal end is connected to the upper boom 13c rotatably vertically. The intermediate jib 15b has a proximal end to be connected to the distal end of the lower jib 15a, that is, the end opposite to the boom 13, and a distal end opposite thereto. The upper jib 15c has a proximal end to be connected to the distal end of the intermediate jib 15b and a distal end opposite thereto, the distal end forming the jib distal end.

The jib derricking device 16 is a device to derrick the jib 15 with respect to the boom 13, specifically, to rotate the jib 15 vertically with respect to the boom 13 about the jib proximal end. The jib derricking device 16 includes a rear strut 16a, a front strut 16f, a jib guy line 16b, a strut guy line 16c, a jib derricking rope 16d, and an unillustrated jib derricking winch. The rear strut 16a and the front strut 16f are connected to the upper boom 13c rotatably vertically. The jib guy line 16b is connected to the distal end of the front strut 16f and the distal end of the jib 15 to interjoin them. The strut guy line 16c and the jib derricking rope 16d interconnect the distal end of the rear strut 16a and the boom 13. The jib derricking winch performs winding and unwinding the jib derricking rope 16d to derrick the rear strut 16a and the front strut 16f with respect to the boom 13, thereby derricking the jib 15 with respect to the boom 13. The jib derricking device 16 may be configured such that the winding and unwinding the jib derricking rope 16d by the jib derricking winch changes the interval between the rear strut 16a and the front strut 16f to thereby derrick the jib 15 with respect to the boom 13. The rear and front struts 16a, 16f may be replaced with a single strut.

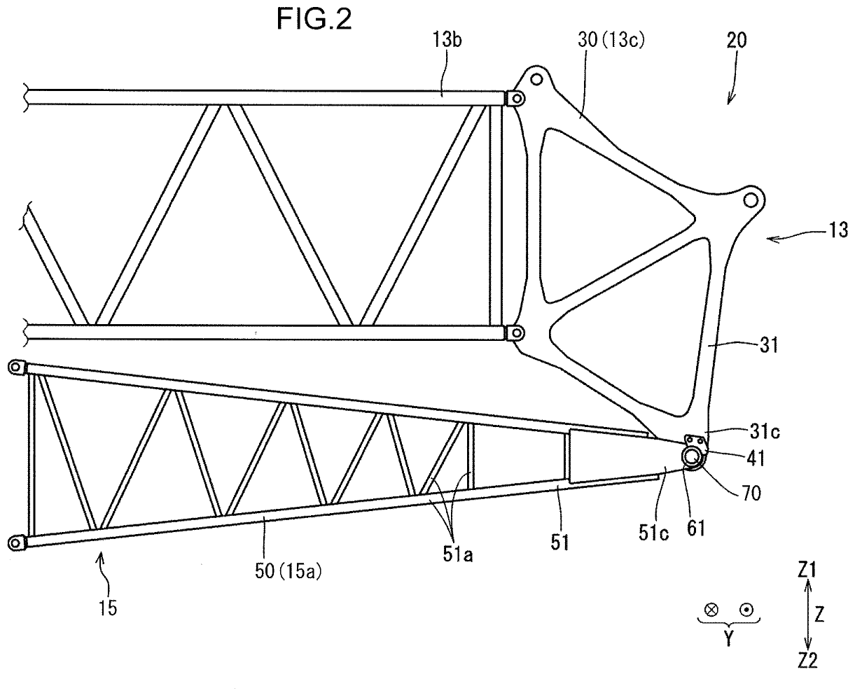

The thus configured work machine 10 includes a unit combination 20. The unit combination 20 is an embodiment of the unit combination according to the present invention. The unit combination 20 includes a first unit 30 and a second unit 50, which units can be interconnected through a pin 70 shown in FIGS. 2 to 4.

Each of the first unit 30 and the second unit 50 is a component of the work machine 10. The pin 70 interconnects the first unit 30 and the second unit 50 so as to allow the second unit 50 to rotate about a rotation axis with the pin 70 as a center relatively to the first unit 30 and to be attached to and detached from the first unit 30. The rotation axis substantially corresponds to the center axis of the pin 70. One unit out of the first unit 30 and the second unit 50 is a derricking unit that is capable of derricking with respect to the other unit. The derricking unit can be selected from the boom 13, the mast 14a, the unillustrated gantry, the jib 15, and the strut (one of the rear strut 16a and the front strut 16f or a single strut) in the work machine 10. Each of the first unit 30 and the second unit 50, alternatively, may be one other than the derricking unit. Examples of the combination of the first unit 30 and the second unit 50 include: the upper boom 13c and the lower jib 15a; the upper boom 13c and the strut; the turning frame 12a and the lower boom 13a; the turning frame 12a and the mast 14a; and vice versa. In the unit combination 20 according to the embodiment shown in FIGS. 2 to 7, the first unit 30 is the upper boom 13c and the second unit 50 is the lower jib 15a.

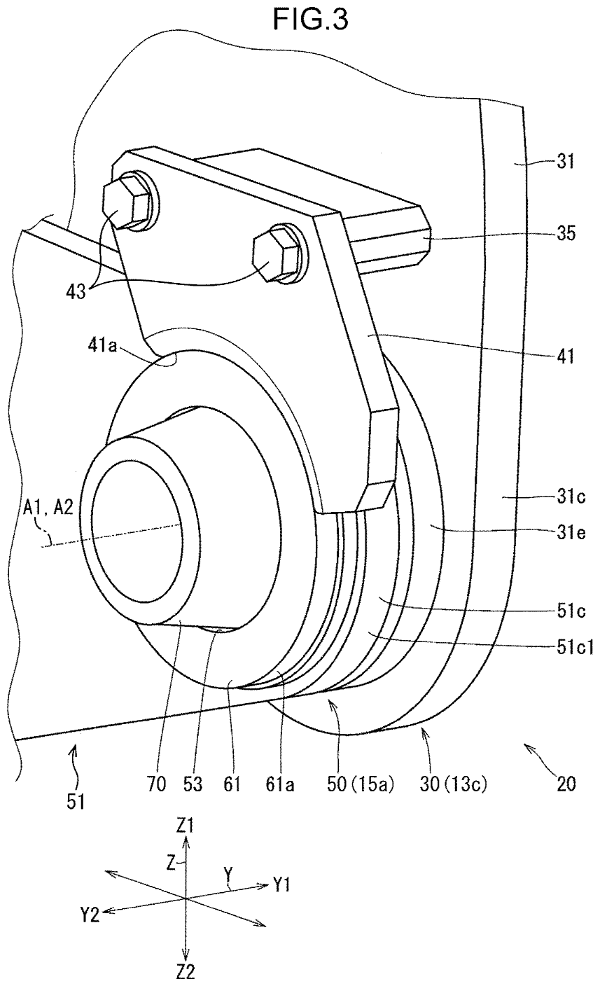

The first unit 30 (the upper boom 13c shown in FIG. 2) includes, as shown in FIG. 3, a first unit body 31, a contact member support part 35, a first contact member 41, and at least one fastening member.

The first unit body 31 is a main body part of the first unit 30. The first unit 30, which is the upper boom 13c in the present embodiment as shown in FIG. 2, includes a body plate 31c and a boss part 31e shown in FIG. 3. The body plate 31c forms an outer surface of the first unit body 31, disposed so as to extend orthogonally to a rotation-axis direction Y parallel to the rotation axis. The body plate 31c is, thus, disposed vertically with a plate thickness direction that is parallel to the rotation-axis direction Y.

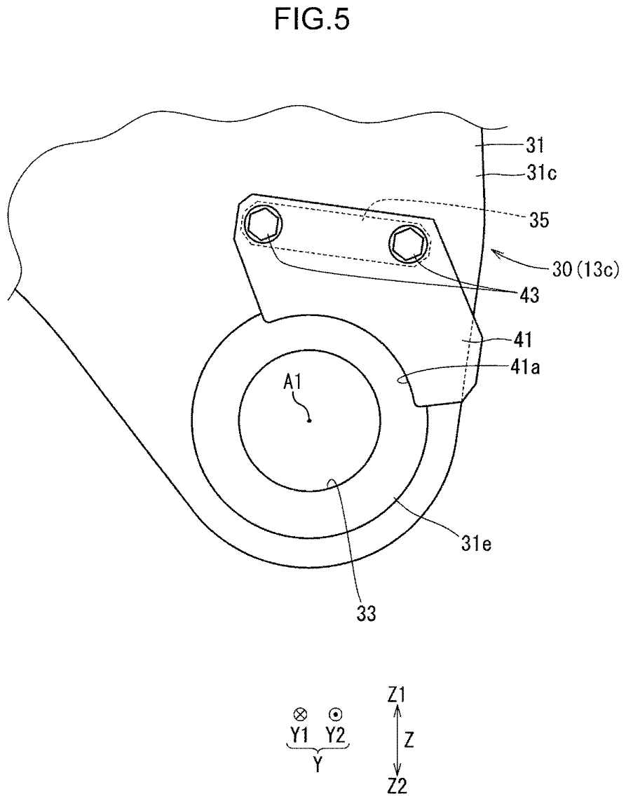

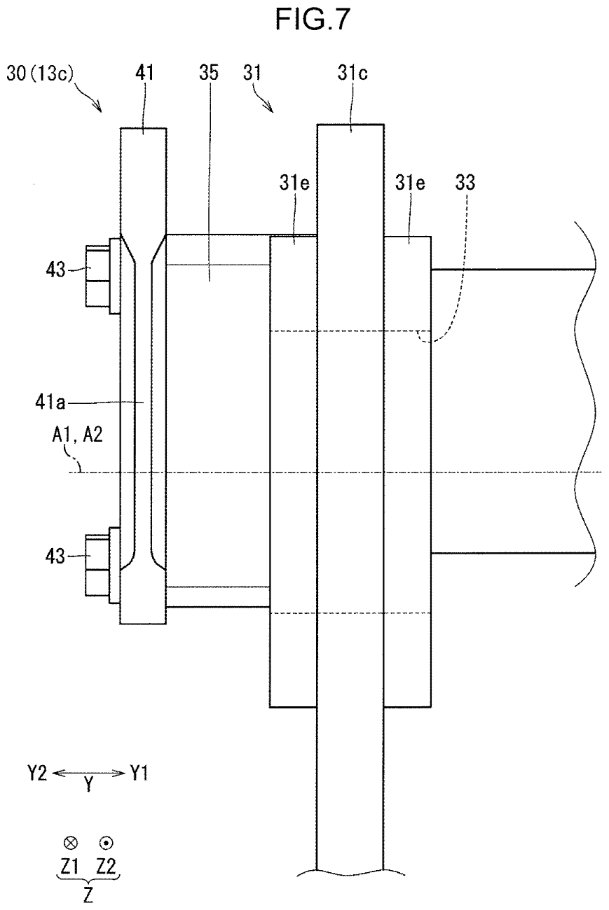

The body plate 31c is formed with a first pin hole 33 shown in FIG. 5. The boss part 31e has an annular shape enclosing the first pin hole 33 as shown in FIG. 5 when viewed in the rotation-axis direction Y. As shown in FIG. 7, the boss part 31e protrudes from the outer side surface of the body plate 31c in the rotation-axis direction Y. The first pin hole 33 has a first center axis A1, which is the center axis of the first pin hole 33 and extends in the rotation-axis direction Y.

The rotation-axis direction Y includes a rotation-axis inward direction Y1 and a rotation-axis outward direction Y2. The rotation-axis inward direction Y1 is a direction toward the first center part along the rotation-axis direction Y, and the rotation-axis outward direction Y2 is a direction away from the first center part along the rotation-axis direction Y. The first center part is the center part of the first unit body 31 in the rotation-axis direction Y, being, in the present embodiment, the center part of the main body plate 31c in the plate thickness direction.

The second unit 50 is attachable to the first unit 30 and detachable from the first unit 30 in the attachment/detachment direction Z shown in FIG. 2. The attachment/detachment direction Z is a direction in which the second unit 50 is attached to and detached from the first unit 30, being orthogonal to the rotation-axis direction Y, that is, a direction coincident or substantially coincident with the vertical direction in FIG. 2. The attachment/detachment direction Z includes a detachment direction Z1 and an attachment direction Z2. The detachment direction Z1 is a direction in which the second unit 50 is detached from the first unit 30, that is, downward direction in the posture shown in FIG. 2. The attachment direction Z2 is a direction in which the second unit 50 is attached to the first unit 30, that is, upward direction in the posture shown in FIG. 2

The first pin hole 33 allows the pin 70 to be inserted through the first pin hole 33 along the rotation-axis direction Y. The first pin hole 33, which has a circular cross section, pierces the first unit body 31 in the rotation-axis direction Y, more specifically, pierces the body plate 31c in the rotation-axis direction Y. The inner peripheral surface of the boss part 31e shown in FIG. 3 is a part of the inner peripheral surface enclosing the first pin hole 33.

As shown in FIG. 3, the contact member support part 35 is interposed between the first unit body 31 and the first contact member 41, thereby enabling the first contact member 41 to be supported by the first unit body 31 through the contact member support part 35 at a position separated from the outer surface of the first unit body 31 (the outer surface of the body plate 31c) in the rotation-axis outward direction Y2. The contact member support part 35 protrudes from the first unit body 31 in the rotation-axis direction Y, in the present embodiment, protrudes from the outer surface of the first unit body 31 in the rotation-axis outward direction Y2. The contact member support part 35 is fixed to each of the first unit body 31 and the first contact member 41. To the first unit body 31, the contact member support part 35 may be either fastened by a fastening member or fixed by welding.

According to the example shown in FIG. 3, the at least one fastening member includes a plurality of bolts 43, fastening the contact member support part 35 together with the first contact member 41 to the body plate 31c to fix them. The contact member support part 35 has a plurality of fastening holes allowing the plurality of bolts 43 to be inserted through the fastening holes, respectively. Each of the fastening holes may be either, for example, a screw hole to be screwed with the bolt 43 or a bolt insertion hole that allows the tip of the bolt 43 to reach the back side of the body plate 31c to allow a nut to be screwed with the tip.

The first contact member 41 has a first contact surface 41a shown in FIG. 5. The first contact member 41 is located in the vicinity of the first pin hole 33. The first contact member 41 illustrated in FIG. 3 is a plate-like member, namely, a contact plate, placed so as to extend orthogonally to the rotation-axis direction Y, that is, so as to render the plate thickness direction of the first contact member 41 parallel to the rotation-axis direction Y. The first contact member 41 and the outer surface of the first unit body 31 (more specifically, the outer surface of the body plate 31c) are spaced in the rotation-axis direction Y. The first contact member 41 is not limited to one having a plate shape, but permitted to be, for example, also in a block shape. The first contact member 41 may be directly fixed to the first unit body 31 without the interposition of the contact member support part 35. Besides, it is also possible to interpose at least one shim between the first contact member 41 and the contact member support part 35. By setting the presence/absence, thickness, number, or the like of the at least one shim, can be adjusted the interval between the first unit body 31 and the first contact member 41 (first contact surface 41a) in the rotation-axis direction Y.

As specifically described below, the first contact member 41 is fastened to the first unit body 31 by the at least one fastening member, in the present embodiment, the plurality of bolts 43. The first contact member 41 has a plurality of insertion holes allowing the plurality of bolts 43 to be inserted through the insertion holes in the rotation-axis direction Y, respectively. The first contact member 41 has a first contact surface 41a detailed later.

The second unit 50, namely, the lower jib 15a in the example shown in FIG. 2, is connected to the first unit 30, namely, the upper boom 13 in the example shown in FIG. 2, through the pin 70 so as to be rotatable relatively to and detachable from the upper boom 13. As shown in FIG. 3, the second unit 50 includes a second unit body 51 and a second contact member 61.

The second unit body 51 is the main body of the second unit 50. In the case shown in FIG. 2 where the second unit 50 is the lower jib 15a, the second unit body 51 includes a plurality of pipes 51a and a pair of connection plates 51c. In FIG. 2, only a part of the plurality of pipes 51a are provide with respective reference signs. The plurality of pipes 51a are arranged to form a lattice structure.

The pair of connection plates 51c constitute a proximal end of the second unit body 51, that is, the jib proximal end in the present embodiment, the proximal end being an end to be connected to the first unit 30 out of opposite ends of the second unit body 51.

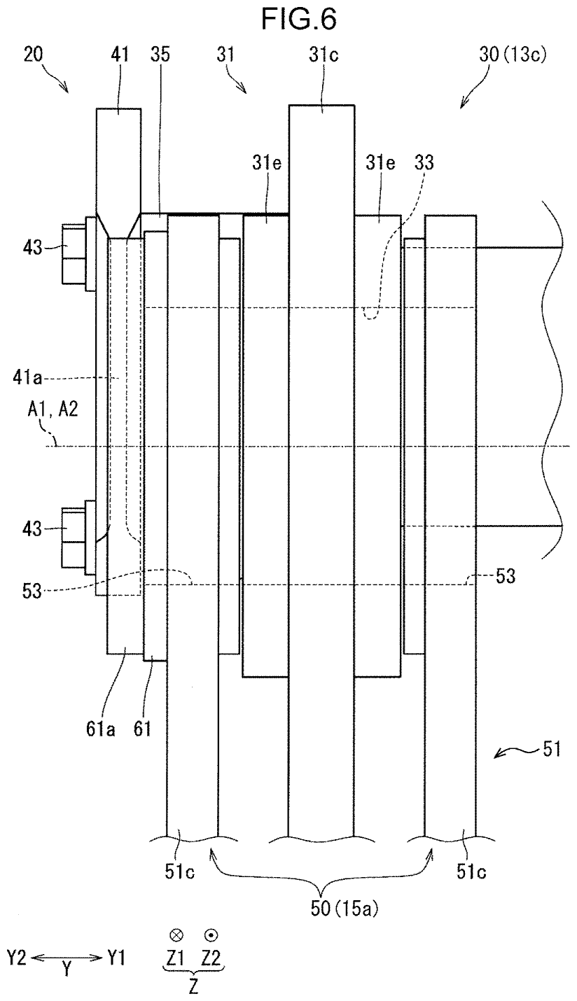

As shown in FIG. 6, the pair of connection plates 51c are disposed so as to render the plate thickness direction of each of the pair of connection plates 51c parallel to the rotation-axis direction Y. The pair of connection plates 51c are spaced in the rotation-axis direction Y, thereby constituting a bifurcated part in the proximal end of the second unit body 51.

The pair of connection plates 51c are connected to the body plate 31c through the pin 70 in the connection arrangement shown in FIG. 6. In the connection arrangement, the main body plate 31c of the first unit body 31 is interposed between the pair of connection plates 51c. In other words, the pair of connection plates 51c are disposed on both outer sides of the body plate 31c in the rotation-axis direction Y. It is also possible, conversely to the embodiment, that the first unit body includes a pair of connection plates forming a bifurcated part and the second unit body includes a connection plate disposed between the pair of connection plates.

The second unit body 51, specifically, each of the connection plates 51c, is formed with a second pin hole 53. The second pin hole 53 has a second center axis A2, which is the center axis of the second pin hole 53 and extends in the rotation-axis direction Y. FIGS. 3, 4, 6 and 7 show a state where the second center axis A2 and the first center axis A1 are perfectly coincident with each other.

The second pin hole 53 allows the pin 70 to be inserted through the second pin hole 53 along the rotation-axis direction Y. The second pin hole 53, which has a circular cross section, pierces the second unit body 51 in the rotation-axis direction Y, more specifically, pierces each of the connection plates 51c in the rotation-axis direction Y.

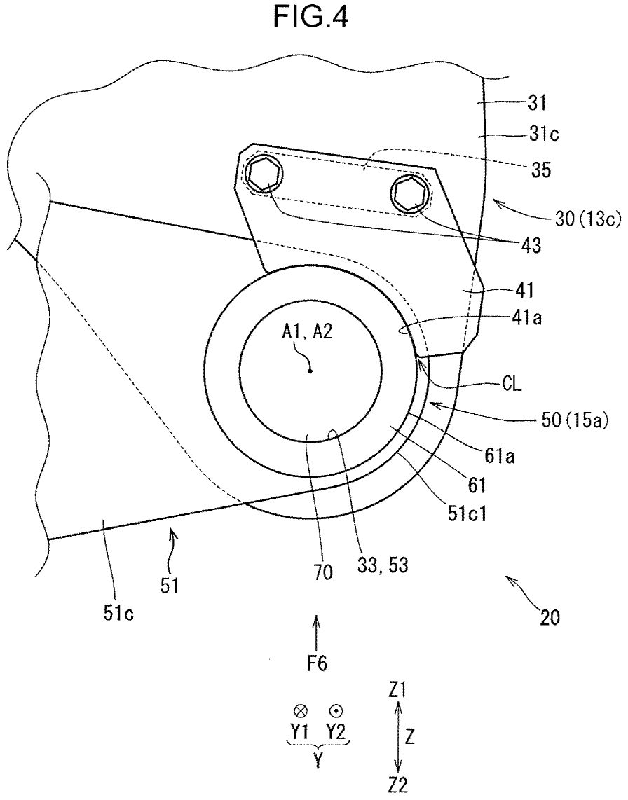

The second contact member 61 constitutes a second contact part contactable with the first contact member 41. The second contact member 61 protrudes from the second unit body 51, specifically, each of the connection plates 51c in the present embodiment, in the rotation-axis direction Y, more specifically, protrudes from the outer side surface of each of the connection plates 51c in the rotation-axis outward direction Y2. As shown in FIG. 4, the second contact member 61 is disposed around the second pin hole 53. More specifically, the second contact member 61 is disposed around the second pin hole 53 along an arc having a center on the second center axis A2 when viewed in the rotation-axis direction Y. The second contact member 61 is, for example, annular. The second contact member 61 has a second contact surface 61a.

The first contact surface 41a of the first contact member 41 in the first unit 30 contacts the second contact surface 61a of the second contact member 61 to thereby allow the first pin hole 33 and the second pin hole 53 to be mutually centered, that is, allow the first center axis A1 and the second center axis A2 to be aligned. As shown in FIG. 4, when viewed in the rotation-axis direction Y, the first contact surface 41a has a shape extending along an arc having a center on the first center axis A1 (matching or substantially matching the arc). The closer the first contact surface 41a to the arc having the center on the first center axis A1, the smaller a clearance CL is. The clearance CL is a clearance formed between the first contact surface 41a and the second contact surface 61a with the pin 70 inserted into the first and second pin holes 33, 53. The first contact surface 41a is preferably a machined surface, more specifically, a cut surface or a ground surface. The first contact surface 41a, however, is not limited to a machined surface.

The first contact surface 41a is included in the surface selected from the outer peripheral surface and the inner peripheral surface of the first contact member 41, the selected surface being a surface closer to the first center axis Al in the radial direction of the first pin hole 33, that is, the inner peripheral surface. The dimension of the first contact surface 41a in the rotation-axis direction Y, namely, the width (thickness) thereof, may be either equal to the dimension (width) of the first contact member 41 in the rotation-axis direction or smaller than that as shown in FIGS. 3 and 7.

The first contact member 41 is located out of hindrance to the removal of the second unit 50 from the first unit 30. Specifically, the first contact member 41 is located at a position deviated from the first center axis Al in the attachment direction Z2, that is, at a position deviated upward in FIGS. 2 and 3, and disposed so as to come into abutment with the second contact surface 61a moving in the attachment direction Z2, that is, so as to receive the second contact surface 61a on the upper side in FIGS. 2 and 3. The central angle of the arc or the substantial arc formed by the first contact surface 41a viewed in the rotation-axis direction Y is 180° or less, preferably 120° or less, being about 100° in the example shown in FIG. 4. The first contact surface 41a is preferably disposed so as to be capable of surface contact with the second contact surface 61a in an area as large as possible upon the interconnection of the first and second units 30, 50. Specifically, the central angle of the arc or the substantial arc formed by the first contact surface part 41a viewed in the rotation-axis direction Y is preferably 90° or more.

As shown in FIG. 3, the at least one fastening member, the plurality of bolts 43 in the present embodiment, fasten the first unit body 31 and the first contact member 41 to each other so as to allow the relative position of the first contact member 41 to the first unit body 31 to be adjusted in a direction orthogonal to the rotation-axis direction Y, that is, in a direction along the vertical surface in the present embodiment. In a state where the fastening is released, for example, a state where each of the bolts 43 is loosened, the first contact member 41 is allowed to make relative displacement to the first unit body 31. Specifically, it is preferable that the bolt insertion hole allowing the bolt 43 to be inserted therethrough in the first contact member 41 has a hole diameter larger than the diameter of the bolt 43. By the difference between the hole diameter and the diameter, the relative position of the first contact member 41 relative to the first unit body 31 and the contact member support part 35 is allowed to be changed, particularly, in a direction orthogonal to the rotation-axis direction (a direction along the outer surface of the first unit body 31 in the above embodiment). The plurality of bolts 43 according to the present embodiment fasten the contact member support part 35 and the first contact member 41 to each other to thereby fasten the first contact member 41 to the first unit body 31 indirectly. The at least one fastening member according to the present invention is, however, not limited thereto but also permitted to perform fastening across the first contact member 41, the contact member support part 35, and the first unit body 31 (e.g., the body plate 31c) in the rotation-axis direction Y to thereby fix (fasten) the first contact member 41 to the first unit body 31. The at least one fastening member, alternatively, may fasten the first contact member 41 and the first unit body 31 directly without the interposition of the contact member support part 35. The at least one fastening member may include only a single fastening member, e.g., a single bolt. Specifically, it is also possible that the first unit body 31 and the first contact member 41 are provided with respective engagement parts that are detachable from each other and the single fastening member fastens the first unit 31 and the first contact member 41 to each other at a position separated from the engagement part.

The second contact surface 61a of the second contact member 61 in the second unit 50 is contactable with the first contact surface 41a upon the interconnection of the first and second units 30, 50. The second contact surface 61a comes into contact, preferably, surface contact, with the first contact surface 41a to thereby allow the first pin hole 33 and the second pin hole 53 to be centered, that is, allow the first center axis A1 and the second center axis A2 to be aligned. The second contact surface 61a is included in the selected surface out of the outer peripheral surface and inner peripheral surface of the second contact member 61, the selected surface being the surface opposite to the second center axis A2, that is, the outer peripheral surface. The second contact surface 61a extends along an arc having a center on the second center axis A2 (matches or substantially matches the arc). The closer the second contact surface 61a to the arc having the center on the second center axis A2, the smaller the clearance CL is. The second contact surface 61a is preferably a machined surface, more specifically, a cut surface or a ground surface. The second contact surface 61a, however, is not limited to machined surfaces.

As shown in FIG. 6, the first and second contact members 41, 61 are preferably disposed on the outer side of the outer surface of the second unit body 51 in the rotation-axis direction Y, the outer surface being, in the present embodiment, the surface facing in the rotation-axis outward direction Y2 in one of the pair of connection plates 51c, specifically, the left side surface of the left connection plate 51c in FIG. 6. This allows the following Effect 1 and Effect 2 to be obtained.

Effect 1: A worker is enabled to visually observe the first and second contact surfaces 41a, 61a easily as shown in FIG. 3. Especially in the case where the first unit 30 includes the contact member support part 35, the contact member support part 35 allows both of respective first and second contact surfaces 41a, 61a of the first and second units 30, 50 to be visually confirmed easily in spite of the location of the second unit body 51 outside the first unit body 31.

Effect 2: It is possible to easily add (post-attach) the first contact member 41 and the second contact member 61 including the first contact surface 41a and the second contact surface 61a, respectively, to the existing first unit 30 and the second unit 50. This effect can be clarified by comparison with a comparative example in which the second contact member 61 and the first contact member 41 are disposed between the second unit 50 and the first unit 30 in the rotation-axis direction Y. In the comparative example, the addition of the first and second contact members 41, 61 requires significant modification of the dimensions of at least one of the first and second units 30, 50 in the rotation-axis direction Y. This hinders the first contact member 41 and the second contact member 61 from being easily added to the existing first unit 30 and the second unit 50. On the other hand, the arrangement shown in FIGS. 3 to 7 allows the first and second contact members 41, 61 to be easily added to the existing first unit 30 and the second unit 50 without significant modification of the dimensions of the first and second contact members 41, 61.

The present invention, however, is not limited to the above arrangements. The present invention also permits the first and second contact members 41, 61 to be disposed on the inner side, in the rotation-axis direction, of the outer surface of the second unit body 51 in the rotation-axis direction Y (e.g., the outer surface of one of the pair of connection plates 51c shown in FIG. 6).

The pair of connection plates 51c of the second unit body 51 have respective body outer peripheral surfaces 51c1 each being an arc-shaped outer peripheral surface having a center on the second center axis A2. On the other hand, as shown in FIG. 4, the second contact surface 61a is included in the outer peripheral surface of the second contact member 61 and located at a position closer to the second center axis A2 in the radial direction of the second pin hole 53 than the body outer peripheral surface 51c1. In summary, the outer peripheral surface of the second contact member 61 including the second contact surface 61a has a radius of curvature smaller than the radius of curvature of the body outer peripheral surface 51c1. This allows the first contact member 41 to have a smaller dimension than that in the case where the body outer peripheral surface 51c1 is used as the second contact surface. The present invention, however, does not exclude an embodiment in which the outer peripheral surface 51c1 of the second unit body 51 is used as the second contact surface.

The first and second units 30, 50 according to the above-described unit combination 20 can be easily interconnected through the pin 70. It is specifically explained as follows.

First, for the interconnection of the first unit 30 and the second unit 50, the second pin hole 53 of the second unit 50 shown in FIG. 4 is relatively brought close to the first pin hole 33 of the first unit 30 shown in FIG. 5 in the attachment direction Z2. Specifically, as shown in FIG. 6, the body plate 31c is inserted into the space between the pair of connection plates 51c, 51c aligned in the rotation-axis direction Y, in the attachment direction Z2 (upward in FIG. 6). Accompanying such mutual approach of the first pin hole 33 and the second pin hole 53, the first contact surface 41a and the second contact surface 61a can come into contact with each other, as shown in FIG. 4. This contact facilitates mutual alignment of the first and second center axes Al, A2, which are respective center axes of the first pin hole 33 and the second pin hole 53, that is, facilitates the mutual centering of the first and second pin holes 33, 53. The first contact surface 41a and the second contact surface 61a, which are capable of mutual surface contact, allows the first contact surface 41a and the second contact surface 61a to be relatively positioned more reliably, that is, allows the centering of the first pin hole 33 and the second pin hole 53 to be more reliably performed, than the case where the first contact surface 41a and the second contact surface 61a is capable of nothing but a line contact. This allows the pin 70 to be easily inserted into both the first pin hole 33 and the second pin hole 53 shown in FIG. 5 with a small force.

The at least one fastening member, namely, the plurality of bolts 43 in the present embodiment, fixes the first contact member 41 to the first unit body 31 so as to allow the relative position of the first contact member 41 to the first unit body 31 o be adjusted. The relative position is set so as to make the first and second center axes A1, A2 as close as possible to each other upon the mutual contact of the first contact surface 41a and the second contact surface 61a. Specifically, the adjustment of the relative position of the first contact surface part 41a to the first unit body 31 is performed, for example, as follows. First, the pin 70 is inserted into both the first and second pin holes 33, 53. Meanwhile, the fastening by the plurality of bolts 43 is loosened to release the fixing of the first contact member 41 to the first unit body 31. In this state, the relative position of the first contact member 41 to the first unit body 31 is adjusted so as to minimize the clearance CL between the first and second contact surfaces 41a, 61a. Following the finish of the adjustment, the plurality of bolts 43 are re-tightened, by which the first contact member 41 is fixed at a proper position relative to the first unit body 31.

In the example shown in FIG. 2, the lower jib 15a is connected to the boom 13 in an inside holding posture with the opposition of the ventral surface of the lower jib 15a, which is the second unit 50 and is a derricking unit, to the ventral surface of the upper boom 13c, which is the first unit 30. In the inside holding posture, the lower jib 15a is positioned directly below the boom 13 while both the lower jib 15a and the boom 13 being horizontal or substantially horizontal.

The effect provided by the of the above-described embodiment is further clarified by the comparison with a comparative example in which the first contact member 41 is fixed to the first unit body 31 by welding. The comparative example requires the clearance CL to be set in consideration with a tolerance due to the welding of the first contact member 41 to the first unit body 31, i.e., with a margin. That is because the clearance CL, if being too small, may cause interference between the first contact surface 41a and the second contact surface 61a during the relative rotation of the first unit 30 and the second unit 50 about the pin 70. The clearance CL, if being too large, conversely, reduces the accuracy of the centering of the first and second pin holes 33, 53 to increase the force required for inserting the pin 70 into both the first and second pin holes 33, 53. For example, the impossibility of the insertion of the pin 70 by human power may cause a special device (e.g., a cylinder) for insertion of the pin 70 to be required. This involves disadvantage such as increase in cost, necessity of securing an arrangement space for the device, and increase in the mass of the entire work machine. In contrast, the unit combination 20 according to the embodiment, in which the plurality of bolts 43 as the at least one fastening member fix the first contact member 41 to the first unit body 31 so as to allow the relative position of the first contact member 41 to the first unit body 31 to be adjusted, enables the first and second pin holes 33, 53 to be centered by the first and second contact surfaces 41a, 61a with high accuracy while preventing the first and second contact surfaces 41a, 61a from mutual interference.

Thus provided is a combination of a first unit and a second unit, each of which is a component of a work machine. The second unit is connectable to the first unit through a pin so as to be rotatable relatively to the first unit about a rotation axis and detachable from the first unit. The first unit includes a first unit body, a first contact member, and at least one fastening member. The first unit body is provided with a first pin hole, which allows the pin to be inserted through the first pin hole in a direction parallel to the rotation axis. The first contact member has a first contact surface, which extends along an arc having a center on the center axis of the first pin hole when viewed in the rotation-axis direction. The second unit includes a second unit body and a second contact part. The second unit body is provided with a second pin hole, which allows the pin to be inserted through the second pin hole in the rotation-axis direction. The second contact part has a second contact surface, which extends along an arc having a center on a center axis of the second pin hole when viewed in the rotation-axis direction and is contactable with the first contact surface. The at least one fastening member fastens the first contact member to the first unit body so as to allow a relative position of the first contact member to the first unit body to be adjusted in a direction orthogonal to the rotation-axis direction.

The at least one fastening member, which allows the relative position of the first contact member to the first unit body to be adjusted, allows the clearance between the first contact surface and the second contact surface to be set small, that is, allows the position of the first center axis and the position of the second center axis to be close to each other upon the mutual contact of the first contact surface and the second contact surface during the interconnection of the first unit and the second unit. This enables the mutual centering of the first pin hole and the second pin hole to be performed with high accuracy (i.e., reduces center deviation). The improvement in the accuracy of the centering allows the force required for the insertion of the pin into both the first and second pin holes to be reduced, eliminating the need for a device for the insertion or allowing the device to be small. This can reduce cost and render the space for placement of the device unnecessary or reduced.

The first contact surface and the second contact surface are preferably capable of mutual surface contact along the respective arcs. This enables the accuracy of the centering of the first and second pin holes to be further improved.

The first contact surface is preferably a cut surface or a ground surface. This allows the first contact surface to be close to the arc having the center on the center axis of the first pin hole with higher accuracy, thereby enabling the accuracy of the centering of the first pin hole and the second pin hole to be further improved.

The second contact surface is preferably a cut surface or a ground surface. This allows the second contact surface to be close to the arc having the center on the center axis of the second pin hole with higher accuracy, thereby enabling the accuracy of the centering of the first pin hole and the second pin hole to be further improved.

The first contact member is preferably disposed on an outer side of the first unit body in the rotation-axis direction. This enables a worker to easily perform a visual observation of the relative positional relationship between the first contact surface included in the first contact member and the second contact surface disposed so as to make contact with the first contact surface.

The first unit, preferably, further includes a contact member support part. The contact member support part protrudes from the first unit body to an outside of the first unit body in the rotation-axis direction and disposed between the first unit body and the first contact member, thereby allowing the first contact member to be supported by the first unit body through the contact member support part at a position separated from the first unit body outward in the rotation-axis direction.

On the other hand, the second contact part preferably protrudes from the second unit body to an outside of the second unit body in the rotation-axis direction and disposed around the second pin hole.

The contact member support part enables the first and second contact surfaces to come into mutual contact while the first contact member is disposed on the outer side of the first unit body in the rotation-axis direction and the second contact part is disposed on the outer side of the second unit body. Besides, it is also made possible to easily add (post-attach) the first contact member and the second contact part to the first unit body and the second unit body, respectively, without great modification of the dimensions of the existing first and second unit bodies in the rotation-axis direction.

The contact member support part preferably supports the first contact member at a position where the first contact member is separated from the first unit body outward in the rotation-axis direction to an extent of locating the second unit body on an outer side of the first unit body in the rotation-axis direction and allowing the second contact surface to come into contact with the first contact surface at a position on an outer side of the second unit body. This allows both the first and second contact surfaces to come into contact with each other on the outer side of the second unit body with the second unit body located on the outer side of the first unit body in the rotation-axis direction, thereby enabling a worker to visually confirm the first and second contact surfaces more easily.

Preferably, the second contact part has an outer peripheral surface having a radius of curvature that is smaller than a radius of curvature of an outer peripheral surface of the second unit body, and the second contact surface is included in the outer peripheral surface of the second contact part. This allows the second contact part to have a small outer diameter to be downsized and lightened compared to the case of using the outer peripheral surface of the second unit body as the second contact surface.

Preferably, one unit of the first unit and the second unit is a derricking unit that is capable of derricking with respect to the other unit of the first unit and the second unit. Although a typical interconnection of the units through a pin so as to allow the derricking unit to derrick, i.e., to vertically rotate, relatively to the other units requires a great force to the extent of requiring a special device (e.g., a hammer or a cylinder), the centering of the first and second pin holes by the first and second contact surfaces can reduce the required force for the insertion of the pin.

For example, it is preferable that the other unit is at least a part of a boom (e.g., an upper boom) and the derricking unit is at least a part (e.g., a lower jib) of a jib that is connected to a distal end of the boom through the pin capably of derricking. This eliminates the need for providing a device to insert the pin 70 into both the first and second pin holes in the vicinity of the connection place between the at least a part of the boom and the at least a part of the jib or allows the device to be downsized. This makes it possible to restrain the overall mass of the combination of the units from increasing. For example, in the case where the work machine is a crane, the lifting capacity of the crane can be improved.

The above-described embodiments may be variously modified. For example, the arrangement and shape of each component of the above embodiment may be changed. For example, the number of components may be changed and some of the components may not be provided. For example, the fixation, connection, etc. of the components may be direct or indirect. For example, what has been described as a plurality of members or parts different from each other may be one member or part. For example, what has been described as one member or part may be divided into a plurality of members or parts different from each other.

1. A unit combination included in a work machine, comprising:
a first unit which is a component of the work machine; and
a second unit which is a component of the work machine, the second unit being connectable to the first unit through a pin so as to be rotatable relatively to the first unit about a rotation axis and detachable from the first unit, wherein:
the first unit includes a first unit body provided with a first pin hole which allows the pin to be inserted through the first pin hole in a rotation-axis direction parallel to the rotation axis, a first contact member having a first contact surface which has a shape extending along an arc having a center on a center axis of the first pin hole when viewed in the rotation-axis direction, and at least one fastening member for fastening the first contact member to the first unit body;
the second unit includes a second unit body provided with a second pin hole which allows the pin to be inserted through the second pin hole in the rotation-axis direction, and a second contact part having a second contact surface which has a shape extending along an arc having a center on a center axis of the second pin hole when viewed in the rotation-axis direction, the second contact part being contactable with the first contact surface; and
the fastening member fastens the first contact member to the first unit body so as to allow a relative position of the first contact member to the first unit body to be adjusted in a direction orthogonal to the rotation-axis direction.

2. The unit combination included in the work machine according to claim 1, wherein the first contact surface and the second contact surface are capable of mutual surface contact along the respective arcs.

3. The unit combination included in the work machine according to claim 1, wherein the first contact surface is a cut surface or a ground surface.

4. The unit combination included in the work machine according to claim 1, wherein the second contact surface is a cut surface or a ground surface.

5. The unit combination included in the work machine according to claim 1, wherein the first contact member is disposed on an outer side of the first unit body in the rotation-axis direction.

6. The unit combination included in the work machine according to claim 5, wherein the first unit further includes a contact member support part, which protrudes from the first unit body to an outside of the first unit body in the rotation-axis direction and disposed between the first unit body and the first contact member to thereby allow the first contact member to be supported by the first unit body through the contact member support part at a position separated from the first unit body outward in the rotation-axis direction, and the second contact part protrudes from the second unit body to an outside of the second unit body in the rotation-axis direction and disposed around the second pin hole.

7. The unit combination included in the work machine according to claim 6, wherein the contact member support part supports the first contact member at a position where the first contact member is separated from the first unit body outward in the rotation-axis direction to an extent of locating the second unit body on an outer side of the first unit body in the rotation-axis direction and allowing the second contact surface to come into contact with the first contact surface at a position on an outer side of the second unit body.

8. The unit combination included in the work machine according to claim 5, wherein the second contact part has an outer peripheral surface having a radius of curvature that is smaller than a radius of curvature of an outer peripheral surface of the second unit body, and the second contact surface is included in the outer peripheral surface of the second contact part.

9. The unit combination included in the work machine according to claim 1, wherein one unit of the first unit and the second unit is a derricking unit that is capable of derricking with respect to the other unit of the first unit and the second unit.

10. The unit combination included in the work machine according to claim 9, wherein the other unit is at least a part of a boom, and the derricking unit is at least a part of a jib to be connected to a distal end of the boom through the pin capably of derricking with respect to the boom.
